(19) United States
(12) Patent Application Publication
(10) Pub. No.: US 2024/0346000 A1
(43) Pub. Date: Oct. 17, 2024

(54) DATA MIGRATION DEVICE, DATA MIGRATION METHOD, AND COMPUTER READABLE MEDIUM

(71) Applicant: Mitsubishi Electric Corporation, Tokyo (JP)

(72) Inventors: Susumu KOSEKI, Tokyo (JP); Satoru TANAKA, Tokyo (JP); Satoshi KAEDE, Tokyo (JP)

(73) Assignee: Mitsubishi Electric Corporation, Tokyo (JP)

(21) Appl. No.: 18/756,301

(22) Filed: Jun. 27, 2024

Related U.S. Application Data
(63) Continuation of application No. PCT/JP2022/004343, filed on Feb. 4, 2022.

(51) Int. Cl. G06F 16/21; G06F 16/2455

(52) U.S. Cl. CPC G06F 16/214; G06F 16/2456; G06F 16/24561

(57) ABSTRACT

A data migration device (10) extracts, from a migration source database (201) in which node information managed in a target record and link information representing a link to another record are managed together in the same table, a record that can be traced based on the link information using origin data as a starting point, and writes the record to an intermediate table (212). The data migration device (10) reads the record from the intermediate table, and separates data of the record into the node information and the link information. The data migration device (10) registers the node information and the link information that have been separated in a migration destination database (202) in which the node information and the link information are managed separately.

### CROSS REFERENCE TO RELATED APPLICATIONS

This application is a Continuation of PCT International Application No. PCT/JP2022/004343, filed on Feb. 4, 2022, which is hereby expressly incorporated by reference into the present application.

### TECHNICAL FIELD

The present disclosure relates to a technology to migrate data to a database with a different data model.

### BACKGROUND ART

DX in the manufacturing industry is being promoted. DX is an abbreviation for digital transformation. In order to advance DX, it is important to realize digital thread that manages data at each stage of a life cycle of a device in a traceable manner. Each stage in the life cycle includes design, manufacture, and operation of the device.

For example, relationships between design data and manufacture data of a device held by a device manufacturer and operation data held by a device operator are tracked and analyzed. This realizes utilization of data such as utilization for improving maintenance efficiency of the device. In order to enable this analysis, the device manufacturer may extract design data and manufacture data from an existing device production management system, and copy and migrate the data to a new data sharing platform. By migrating the data to the data sharing platform, data sharing with a stakeholder such as the device operator can be realized.

In order to flexibly manage the relationships of data at each stage, a data model in which objects of node information and objects of link information are separated is required. The node information is data to be managed. The link information is data representing a link with other node information. In legacy systems such as existing device production management systems, node information and link information are often managed together. When node information and link information are managed together, data migration requires conversion of a data model before migration.

Patent Literature 1 describes a technology to migrate data between databases with different structures. In Patent Literature 1, data is migrated using a program that converts data of a migration source into data that conforms to the structure of a migration destination.

### CITATION LIST

### Patent Literature

Patent Literature 1: JP 2013-41526 A

### SUMMARY OF INVENTION

### Technical Problem

It is conceivable to migrate only data related to a target device operator among device data held by a device manufacturer. In this case, it is necessary to identify data associated with a condition and convert a data model, and then register the data in a database of a migration destination. Patent Literature 1 does not describe identifying data associated with a condition.

A series of processes to identify data related to a condition and convert a data model is complex. Therefore, it is a heavy burden to develop a program for each combination of a migration source database and a migration destination database.

An object of the present disclosure is to make it possible to easily migrate data associated with a condition among data of a migration source database in which node information and link information are both present to a migration destination database in which node information and link information are managed separately.

### Solution to Problem

A data migration device according to the present disclosure includes a data extraction unit to extract a record from a migration source database in which node information managed in a target record and link information representing a link to another record are managed together in a same table, the record being a record that can be traced based on the link information using origin data as a starting point, and write the record to an intermediate table;
a separation unit to read, from the intermediate table, the record extracted by the data extraction unit, and separate data of the record into the node information and the link information; and
a data registration unit to register the node information and the link information separated by the separation unit in a migration destination database in which the node information and the link information are managed separately.

### Advantageous Effects of Invention

In the present disclosure, a record that can be traced based on link information using origin data as a starting point is extracted and written to an intermediate table. That is, node information and link information associated with the origin data are collectively written to the intermediate table. Then, the data in the intermediate table is separated into the node information and the link information and written to a migration destination database.

By separating processes using the intermediate table, the processes are simplified. This reduces the burden on development of a program or the like necessary for migration, and makes it possible to easily migrate data.

### BRIEF DESCRIPTION OF DRAWINGS

FIG. 1 is a figure describing an overview of data migration realized in Embodiment 1;

FIG. 2 is a configuration diagram of a data migration system 1 according to Embodiment 1;

FIG. 3 is a configuration diagram of a data migration device 10 according to Embodiment 1;

FIG. 4 is a flowchart of an outline of a data migration process according to Embodiment 1;

FIG. 5 is a flowchart of a data extraction process (step S102 in FIG. 4) according to Embodiment 1;

FIG. 6 is a flowchart of a separation process (step S103 in FIG. 4) according to Embodiment 1;

FIG. 7 is a figure describing a specific example of the data extraction process (step S102 in FIG. 4) according to Embodiment 1;

FIG. 8 is a figure describing a specific example of the separation process (step S103 in FIG. 4) according to Embodiment 1;

FIG. 9 is a flowchart of a process of generating a query that searches for migration target data according to Embodiment 1;

FIG. 10 is a figure describing an inter-table link 34 according to Embodiment 1;

FIG. 11 is a figure illustrating an example of a template query according to Embodiment 1;

FIG. 12 is a figure illustrating an example of the template query according to Embodiment 1;

FIG. 13 is a figure describing an intra-table link 35 according to Embodiment 1;

FIG. 14 is a figure illustrating an example of the template query according to Embodiment 1;

FIG. 15 is a figure illustrating an example of the template query according to Embodiment 1;

FIG. 16 is a figure illustrating an example of part of an extraction query where a search for migration target data is performed according to Embodiment 1;

FIG. 17 is a flowchart of a process of generating a query including acquirement and registration of data items according to Embodiment 1;

FIG. 18 is a figure describing supplementary information 37 according to Embodiment 1;

FIG. 19 is a figure illustrating an example of the template query according to Embodiment 1;

FIG. 20 is a figure illustrating an example of an extraction query generated in an item addition process (step S504 in FIG. 17) according to Embodiment 1;

FIG. 21 is a figure describing an intra-table node 36 according to Embodiment 1;

FIG. 22 is a figure illustrating an example of an extraction query generated in an acquirement item setting process (step S505 in FIG. 17) according to Embodiment 1;

FIG. 23 is a figure illustrating an example of an extraction query generated in a registration process setting process (step S506 in FIG. 17) according to Embodiment 1;

FIG. 24 is a configuration diagram of the data migration device 10 according to Variation 1;

FIG. 25 is a configuration diagram of the data migration system 1 according to Embodiment 2;

FIG. 26 is a flowchart of an outline of the data migration process according to Embodiment 2;

FIG. 27 is a figure describing a specific example of a case where formats of join keys are different between linked tables in a migration source table 101 according to Embodiment 2; and

FIG. 28 is a figure describing a specific example of a case where a format of a primary key needs to be changed between the migration source table 101 and a migration destination table 102 according to Embodiment 2.

### DESCRIPTION OF EMBODIMENTS

### Embodiment 1

### Description of Overview

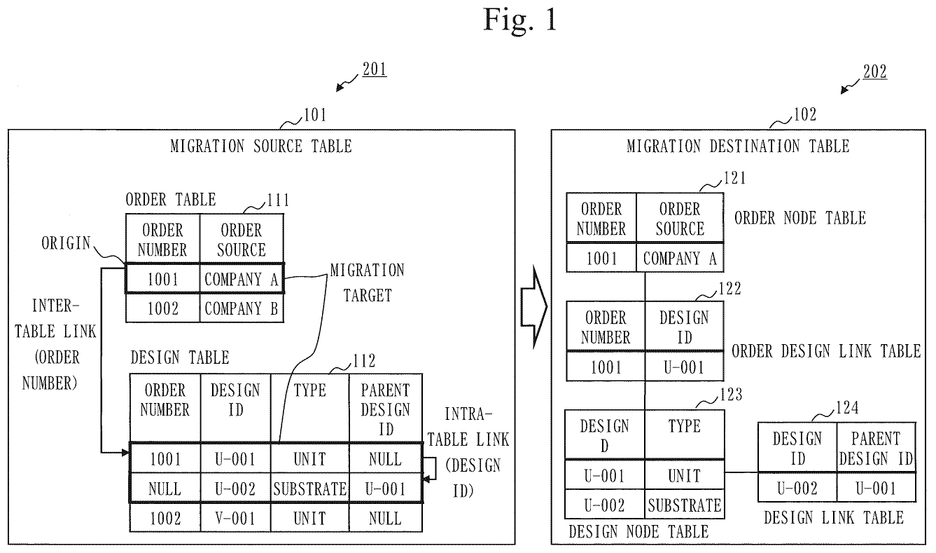

Referring to FIG. 1, an overview of data migration realized in Embodiment 1 will be described.

In Embodiment 1, data associated with a condition is migrated from a migration source database 201 to a migration destination database 202. In the migration source database 201, node information and link information are managed together. In the migration destination database 202, node information and link information are managed separately.

As a case where only data associated with a condition is migrated, treating data associated with a new order as migration target is conceivable. By migrating only data related to a new order, a data update of the migration source database 201 can be reflected in the migration destination database 202. As a case where only data associated with a condition is migrated, migrating data associated with a specific customer is also conceivable. By migrating only data associated with a specific customer, data can be shared only with a target stakeholder.

The left side of FIG. 1 indicates a specific example of the migration source database 201.

A migration source table 101 in the migration source database 201 includes an order table 111 and a design table 112. In the order table 111, order information is managed based on an order number and an order source. In the design table 112, design information is managed based on an order number, a design ID, a type, and a parent design ID. ID is an abbreviation for identifier. A link between order information and design information is expressed by the value of an order number in the order table 111 and the design table 112. A link of a parent-child relationship of design information is managed based on a design ID and a parent design ID in the design table 112.

In this way, in the migration source database 201, intra-table or inter-table link information is managed together with node information. A data migration device 10 uses data that meets a specific condition as origin data, and extracts data associated with the origin data from the migration source table 101. Then, the data migration device 10 converts the data model of the extracted data so that node information and link information are separated, and then copies and migrates the data.

The right side of FIG. 1 indicates a specific example of the migration destination database 202. The right side of FIG. 1 indicates a result of data migration when data of order number 1001 in the order table 111 is origin data.

In a migration destination table 102 in the migration destination database 202, node tables that manage node information and link tables that manage link information are separated. The node tables are an order node table 121 and a design node table 123. The link tables are an order design link table 122 and a design link table 124.

Pieces of data associated with the origin data by an inter-table link and an intra-table link are design ID U-001 and design ID U-002 in the design table 112. Therefore, these pieces of data are migration target data. The data migration device 10 separates the migration target data into node information and link information, and registers them in the migration destination table 102 in the migration destination database 202.

It is assumed that in actual data migration, there are many tables and data items, and there are links with multi-level parent-child relationships.

### Description of Configuration

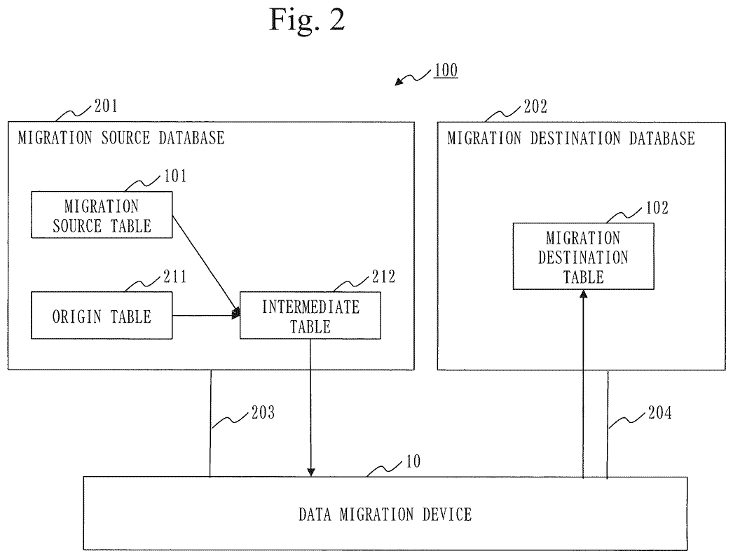

Referring to FIG. 2, a configuration of a data migration system 1 according to Embodiment 1 will be described.

The data migration system 1 includes the data migration device 10, the migration source database 201, and the migration destination database 202. The data migration device 10 is connected with the migration source database 201 through a transmission channel 203. The data migration device 10 is connected with the migration destination database 202 through a transmission channel 204.

The data migration device 10 is a computer that performs data migration from the migration source database 201 to the migration destination database 202. The migration source database 201 is a database in which node information and link information are managed together. In Embodiment 1, the migration source database 201 is a relational database operated using SQL. SQL is an abbreviation for Structured Query Language. The migration destination database 202 is a database in which node information and link information are managed separately.

The migration source database 201 includes the migration source table 101, an origin table 211, and an intermediate table 212. The migration destination database 202 includes the migration destination table 102.

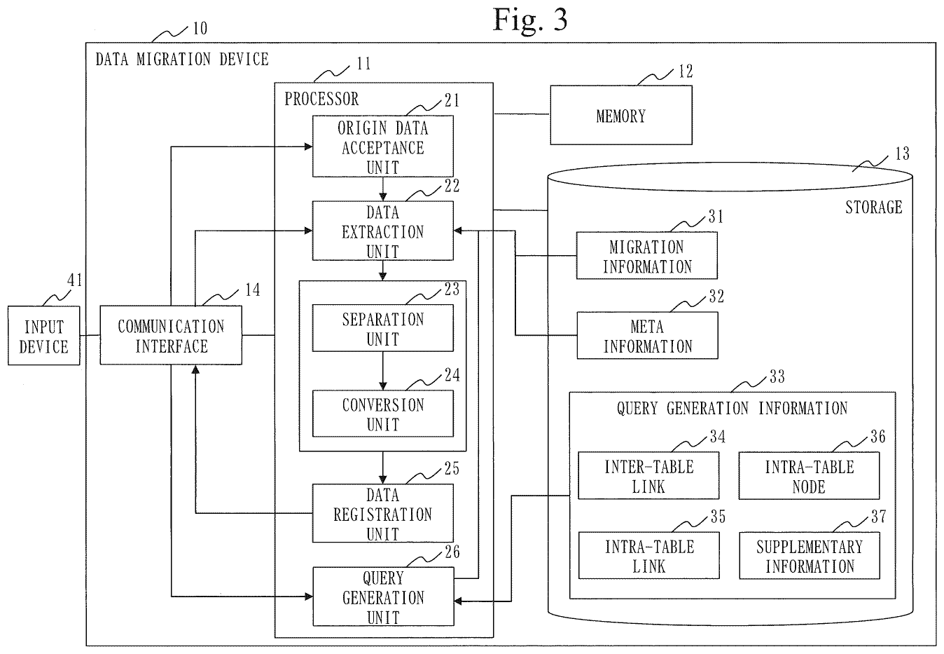

Referring to FIG. 3, a configuration of the data migration device 10 according to Embodiment 1 will be described.

The data migration device 10 includes hardware of a processor 11, a memory 12, a storage 13, and a communication interface 14. The processor 11 is connected with other hardware components via signal lines and controls these other hardware components.

The processor 11 is an IC that performs processing. IC is an abbreviation for integrated circuit. Specific examples of the processor 11 are a CPU, a DSP, and a GPU. CPU is an abbreviation for central processing unit. DSP is an abbreviation for digital signal processor. GPU is an abbreviation for graphics processing unit.

The memory 12 is a storage device to temporarily store data. Specific examples of the memory 12 are an SRAM and a DRAM. SRAM is an abbreviation for static random access memory. DRAM is an abbreviation for dynamic random access memory.

The storage 13 is a storage device to store data. A specific example of the storage 13 is an HDD. HDD is an abbreviation for hard disk drive. Alternatively, the storage 13 may be a portable recording medium such as an SD (registered trademark) memory card, CompactFlash (registered trademark), a NAND flash, a flexible disk, an optical disc, a compact disc, a Blu-ray (registered trademark) disc, and a DVD. SD is an abbreviation for Secure Digital. DVD is an abbreviation for digital versatile disk.

The communication interface 14 is an interface for communicating with external devices. Specific examples of the communication interface 14 are an Ethernet (registered trademark) port, a USB port, and an HDMI (registered trademark) port. USB is an abbreviation for Universal Serial Bus. HDMI is an abbreviation for High-Definition Multimedia Interface.

The data migration device 10 is connected with the migration source database 201 and the migration destination database 202 through the communication interface 14. The data migration device 10 is also connected with an input device 41 through the communication interface 14. The input device 41 is a device that accepts an input from a user using a GUI or the like. GUI is an abbreviation for graphical user interface.

The data migration device 10 includes, as functional components, an origin data acceptance unit 21, a data extraction unit 22, a separation unit 23, a conversion unit 24, a data registration unit 25, and a query generation unit 26. The functions of the functional components of the data migration device 10 are realized by software.

The storage 13 stores programs that realize the functions of the functional components of the data migration device 10. These programs are read into the memory 12 by the processor 11 and executed by the processor 11. This realizes the functions of the functional components of the data migration device 10.

The storage 13 stores migration information 31, meta information 32, and query generation information 33. The query generation information 33 includes an inter-table link 34, an intra-table link 35, an intra-table node 36, and supplementary information 37.

FIG. 1 illustrates only one processor 11. However, there may be a plurality of processors 11, and the plurality of processors 11 may cooperate to execute the programs to realize the functions.

### Description of Operation

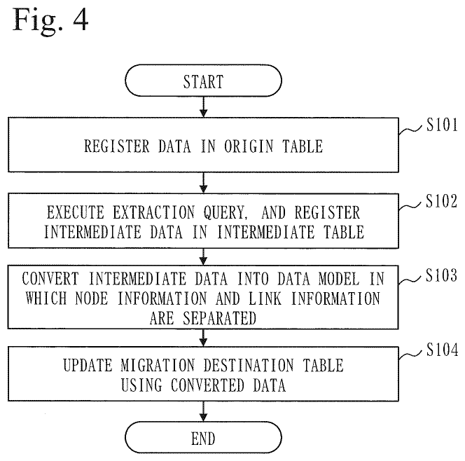

Referring to FIGS. 4 to 23, the operation of the data migration device 10 according to Embodiment 1 will be described.

A procedure for the operation of the data migration device 10 according to Embodiment 1 is equivalent to a data migration method according to Embodiment 1. A program that realizes the operation of the data migration device 10 according to Embodiment 1 is equivalent to a data migration program according to Embodiment 1.

The operation of the data migration device 10 according to Embodiment 1 includes a data migration process and a query generation process.

Referring to FIG. 4, an outline of the data migration process according to Embodiment 1 will be described.

### (Step S101: Origin Data Acceptance Process)

The origin data acceptance unit 21 accepts origin data to be registered in the origin table 211. The origin data is data that is the starting point for tracking migration target data. As the origin data, order data of a new order or order data from a specific customer is conceivable, for example.

### (Step S102: Data Extraction Process)

The data extraction unit 22 executes an extraction query to extract migration target data, and writes the migration target data to the intermediate table 212 as intermediate data. When there are a plurality of extraction queries, the data extraction unit 22 sequentially executes the plurality of extraction queries to extract migration target data corresponding to each extraction query, and writes the migration target data to the intermediate table 212 as intermediate data. Processing represented by an extraction query is actually performed by a DBMS of the migration source database 201. DBMS is an abbreviation for database management system. In Embodiment 1, an extraction query is an SQL statement. Intermediate data is written to one intermediate table 212 by one extraction query.

Extraction queries are generated in advance by the query generation process and are stored in the storage 13.

### (Step S103: Separation Process)

The separation unit 23 acquires the intermediate data stored in the intermediate table 212. The separation unit 23 separates the intermediate data into node information and link information. That is, the separation unit 23 converts the intermediate data into a data model in which objects of the node information and objects of the link information are separated. At this time, if data conversion is necessary, the conversion unit 24 converts the intermediate data.

### (Step S104: Data Registration Process)

The data registration unit 25 receives the node information and the link information separated in step S103, and registers them in the migration destination table 102 in the migration destination database 202. Registering is not limited to registering new data and includes updating existing data. This registration is performed by an appropriate method depending on the method by which the migration destination table 102 is realized.

An extraction query is generated by the query generation unit 26. At this time, items and types of intermediate data are also determined concurrently. Therefore, a definition query that defines the intermediate table 212 is also generated in addition by the query generation unit 26.

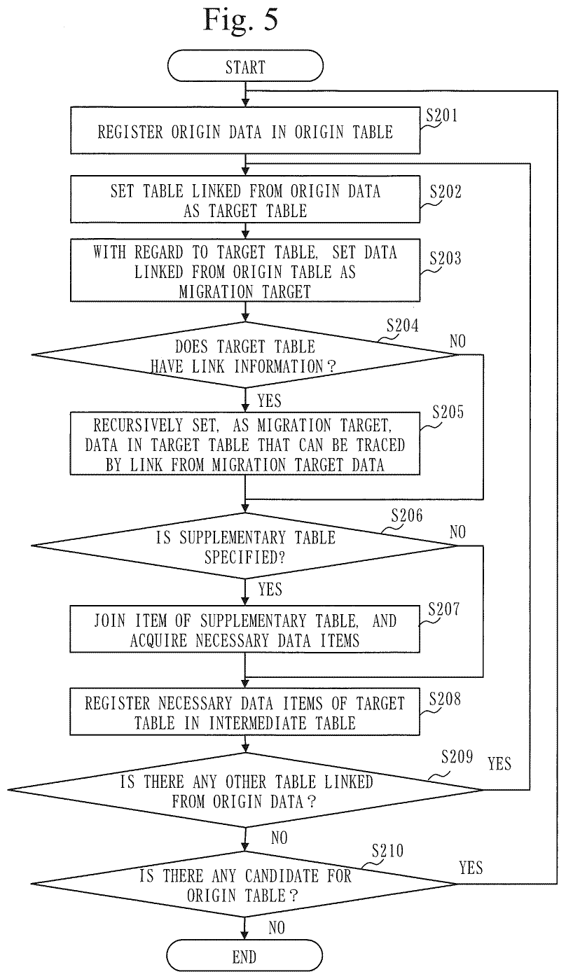

Referring to FIGS. 5 to 8, details of the data migration process according to Embodiment 1 will be described.

The intermediate table 212 is used to temporarily store data that can be traced from origin data in a migration source table as migration target data. In the migration destination database 202, a node table that manages node information and a link table that manages link information are provided separately. The intermediate table 212 is prepared for each node table in the migration destination database 202. Each intermediate table 212 has data items of node information and data items necessary to generate link information indicating a link to a parent side. This allows a node table and a link table to be created from the intermediate table 212.

Note that the parent side is a source side reached by tracing a link for node information. That is, the link information to the node information of the parent side is stored together with the node information of a child side.

In the following description, a data extraction process (step S102 in FIG. 4) will be described first. Then, a separation process (step S103 in FIG. 4) will be described.

Referring to FIG. 5, the data extraction process (step S102 in FIG. 4) according to Embodiment 1 will be described.

In the flowchart indicated in FIG. 5, if an anormal termination occurs in each step, illustration of operation to terminate the process at that point is omitted. The same also applies to all flowcharts below.

### (Step S201: Origin Data Registration Process)

The data extraction unit 22 registers the origin data accepted in step S101 in the origin table 211. For example, new order data based on an order date, order data from a specific customer, or data based on a combination of these conditions is registered in the origin table 211. The origin data is registered by executing an SQL statement created in advance or the like.

### (Step S202: Target Table Setting Process)

The data extraction unit 22 refers to the migration information 31, and sets one table linked by link information from the origin data registered in the origin table 211 as a target table. The data extraction unit 22 generates a corresponding table corresponding to the target table as the intermediate table 212.

The migration information 31 is setting information necessary for data migration. For example, the migration information 31 is database definition information for the migration source database 201 and the migration destination database 202. The database definition information includes inter-table relationship information indicating a link relationship among one or more tables constituting the migration source table 101 and intra-table relationship information indicating a link relationship within a table. The inter-table relationship information indicates which item in one table and which item in the other table link a record in the one table and a record in the other table. The intra-table relationship information indicates which item and which item in a table link records in that table.

The data extraction unit 22 can identify a table linked from the origin data by referring to the inter-table relationship information about the migration source database 201. The data extraction unit 22 may refer to the meta information 32 as necessary.

The relationships among the tables constituting the migration source table 101 can be regarded as a tree structure with the origin table 211 as the root. Target tables are selected sequentially from the parent side so that all tables to be migration targets are set as target tables. By branching in step S209, all tables that are connected to the origin table 211 and to be migration targets are selected as target tables. As a result, child tables of the origin table 211 are identified and migration target data is extracted. Then, by branching in step S210, each identified child table is set as a new origin table 211, and all tables that are connected to the new origin table 211 and are to be migration targets are selected as target tables. By repeating this recursively, all tables to be migration targets are selected as target tables in the end.

The data extraction unit 22 executes an extraction query on each target table. By this, the processes of steps S203 to S208 are performed. As a result, migration target data extracted from each target table is registered in an intermediate table as intermediate data. That is, the processes of steps S203 to S208 are performed by the DBMS in the migration source database 201 based on extraction queries.

### (Step S203: First Extraction Process)

The data extraction unit 22 extracts data of a record in the target table linked from the origin data by link information as migration target data. That is, the data extraction unit 22 extracts data in a record in the target table linked from the origin data by inter-table link information as migration target data.

It is assumed here that data of all items in the record is acquired. However, only data of some items in the record may be acquired. Each item whose data is to be acquired is specified when an extraction query is generated.

### (Step S204: Intra-Table Link Determination Process)

The data extraction unit 22 determines whether the target table has intra-table information. Specifically, the data extraction unit 22 refers to the intra-table relationship information regarding the migration source database 201 included in the migration information 31. This makes it possible to determine whether there is intra-table link information.

If there is intra-table link information, the data extraction unit 22 advances the process to step S205. If there is no intra-link information, the data extraction unit 22 advances the process to step S206.

### (Step S205: Second Extraction Process)

The data extraction unit 22 extracts data of another record in the target table linked by the intra-table link information from the data in the record extracted from the target table in step S203, as migration target data.

Further, the data extraction unit 22 extracts data of yet another record in the target table linked from the extracted other record by the intra-table link information, as migration target data. By repeating this process recursively, the data extraction unit 22 extracts all pieces of data in records that can be traced by the link information in the target table, as migration target data.

Here, data of the same item as in step S203 is acquired.

### (Step S206: Supplementary Determination Process)

The data extraction unit 22 determines whether a supplementary table to be joined to the target table is specified. Specifically, it is determined whether a supplementary table has been specified in generating the extraction query.

In actual data migration, there may be a case where items managed in a different table in the migration source database 201 need to be managed in the same table in the migration destination database 202. In this case, the different table is specified as a supplementary table.

If a supplementary table is specified, the data extraction unit 22 advances the process to step S207. If a supplementary table is not specified, the data extraction unit 22 advances the process to step S208.

### (Step S207: Third Extraction Process)

The data extraction unit 22 adds items in the supplementary table to the corresponding table. The data extraction unit 22 sets each of one or more records extracted in steps S203 and S205 as a processing target record. The data extraction unit 22 extracts data of a record in the supplementary table that satisfies a join condition with data of the processing target record. Then, the data extraction unit 22 joins the extracted data to the data of the processing target record.

The join condition is a condition for joining data in the supplementary table to data in the target table. The join condition is, for example, a match between key items or the like.

### (Step S208: Table Registration Process)

The data extraction unit 22 writes the migration target data extracted in steps S203 and S205 to the target table. At this time, if there is data joined in step S207, the joined data is also written to the target table.

### (Step S209: Target Table Determination Process)

The data extraction unit 22 determines whether there is a table that is linked from the origin data registered in the origin table 211 by link information and has not been processed.

If there is a table that has not been processed, the data extraction unit 22 returns the process to step S202. If there is no table that has not been processed, the data extraction unit 22 advances the process to step S210.

### (Step S210: Intermediate Table Determination Process)

The data extraction unit 22 determines whether there is an intermediate table 212 that is a candidate for the origin table 211 and has not been processed.

In the initial step S201, the origin data accepted in step S101 is registered in the origin table 211. However, it may be possible to use data linked from the origin data as new origin data and further trace the link. Therefore, the data extraction unit 22 determines whether there is an intermediate table 212 that is a candidate for the origin table 211 and has not been processed among the intermediate tables 212 storing data linked from the origin data.

If there is an intermediate table 212 that is a candidate for the origin table 211 and has not been processed, the data extraction unit 22 returns the process to step S201. Then, in step S201, the data extraction unit 22 registers data of that intermediate table 212 in the origin table 211 as origin data, and performs the processes of step S202 and subsequent steps. If there is no intermediate table 212 that is a candidate for the origin table 211 and has not been processed, the data extraction unit 22 ends the process.

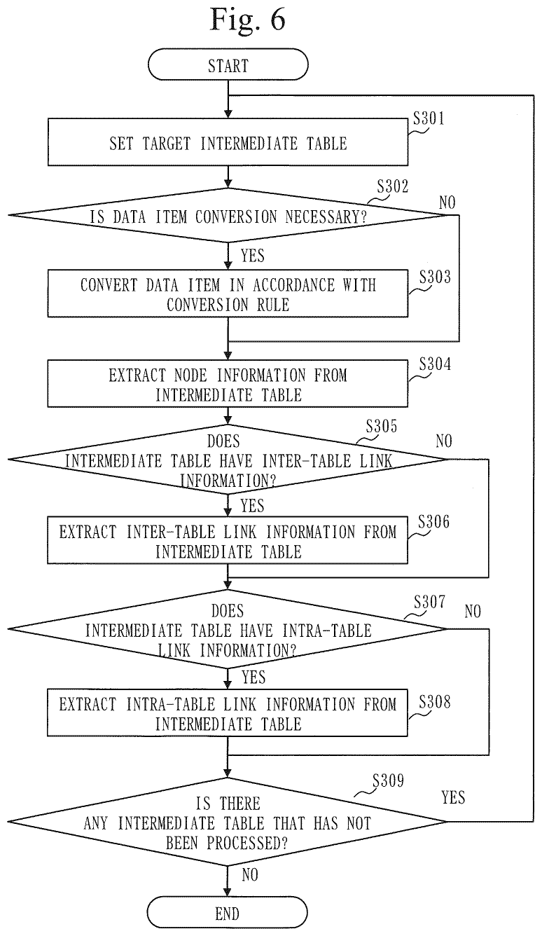

Referring to FIG. 6, the separation process (step S103 in FIG. 4) according to Embodiment 1 will be described.

### (Step S301: Table Setting Process)

The separation unit 23 sets one intermediate table 212 as a target intermediate table 212. For example, the separation unit 23 sets each intermediate table 212 as the target intermediate table 212 in the order of being created in step S102.

By branching in step S309, all the intermediate table 212 are selected in the end.

### (Step S302: Conversion Necessity Determination Process)

The conversion unit 24 determines whether data item conversion is necessary for the target intermediate table 212.

Specifically, the conversion unit 24 determines whether the target intermediate table 212 includes an item in which specified data for which a conversion rule is specified is set. The conversion rule is specified in advance by a user. If an item in which specified data is set is included, the conversion unit 24 determines that data item conversion is to be performed. If an item in which specified data is set is not included, the conversion unit 24 determines that data item conversion is not to be performed.

If data item conversion is to be performed, the conversion unit 24 advances the process to step S303. If data item conversion is not to be performed, the conversion unit 24 advances the process to step S304.

### (Step S303: Item Conversion Process)

The conversion unit 24 converts the specified data that is set in the intermediate table 212 in accordance with the conversion rule. Possible conversion processes here include a process of increasing or decreasing the number of data items and a process of changing the value, type, or the like of a data item. The process of increasing or decreasing the number of data items is addition, division, or integration of data items.

### (Step S304: Node Output Process)

The separation unit 23 extracts node information from the target intermediate table 212.

Specifically, the separation unit 23 refers to the inter-table relationship information and the intra-table relationship information included in the migration information 31. The separation unit 23 extracts, as node information, data of items excluding items linked with the parent-side table in the inter-table relationship information and items linked with the parent-side record in the intra-table relationship information. The extracted node information is passed to the data registration unit 25. Then, in step S104 in FIG. 4, the node information is registered in a corresponding table in the migration destination table 102 in the migration destination database 202 by the data registration unit 25.

It is assumed that a registration destination table in the migration destination database 202 is specified by the user for each table in the migration source database 201. The intermediate table 212 is generated for each table in the migration source database 201. Therefore, the registration destination table in the migration destination database 202 is identified for each intermediate table 212. It is assumed that the registration target table is specified for each of node information, inter-table link information, and intra-table link information. If there are a plurality of pieces of intra-table link information, the registration destination table is specified for each piece of link information.

### (Step S305: Inter-Table Link Determination Process)

The separation unit 23 determines whether the target intermediate table 212 has inter-table link information. Specifically, the separation unit 23 refers to the inter-table relationship information regarding the migration source database 201 included in the migration information 31. This makes it possible to determine whether there is inter-table link information. Note that intermediate data is collected by tracing a link from origin data, and thus basically has inter-table link information. However, origin data is data that is the top of a link, and thus does not have inter-table link information.

If there is inter-table link information, the separation unit 23 advances the process to step S306. If there is no inter-table link information, the separation unit 23 advances the process to step S307.

### (Step S306: Inter-Table Link Output Process)

The separation unit 23 extracts the inter-table link information from the target intermediate table 212. Specifically, the separation unit 23 extracts, as the inter-table link information, an item linked with the parent table in the inter-table relationship information included in the migration information 31. The extracted inter-table link information is passed to the data registration unit 25. Then, in step S104 in FIG. 4, the inter-table link information is registered in a corresponding table in the migration destination table 102 in the migration destination database 202 by the data registration unit 25.

### (Step S307: Intra-Table Link Output Process)

The separation unit 23 determines whether the target intermediate table 212 has intra-table link information. Specifically, the separation unit 23 refers to the intra-table relationship information regarding the migration source database 201 included in the migration information 31. This makes it possible to determine whether there is intra-table link information.

If there is intra-table link information, the separation unit 23 advances the process to step S308. If there is no intra-table link information, the separation unit 23 advances the process to step S309.

### (Step S308: Intra-Table Link Output Process)

The separation unit 23 extracts the intra-table link information from the target intermediate table 212. Specifically, the separation unit 23 extracts, as the intra-table link information, an item linked with the parent-side record in the intra-table relationship information included in the migration information 31. The extracted intra-table link information is passed to the data registration unit 25. Then, in step S104 in FIG. 4, the intra-table link information is registered in a corresponding table in the migration destination table 102 in the migration destination database 202 by the data registration unit 25.

### (Step S309: Intermediate Table Determination Process)

The separation unit 23 determines whether there is an intermediate table 212 that has not been processed and has not been set as the target intermediate table 212. That is, the separation unit 23 determines whether there is an intermediate table 212 on which the processes of steps S302 to S308 have not been performed.

If there is an intermediate table 212 that has not been processed, the separation unit 23 returns the process to step S301. If there is no intermediate table 212 that has not been processed, the separation unit 23 ends the process.

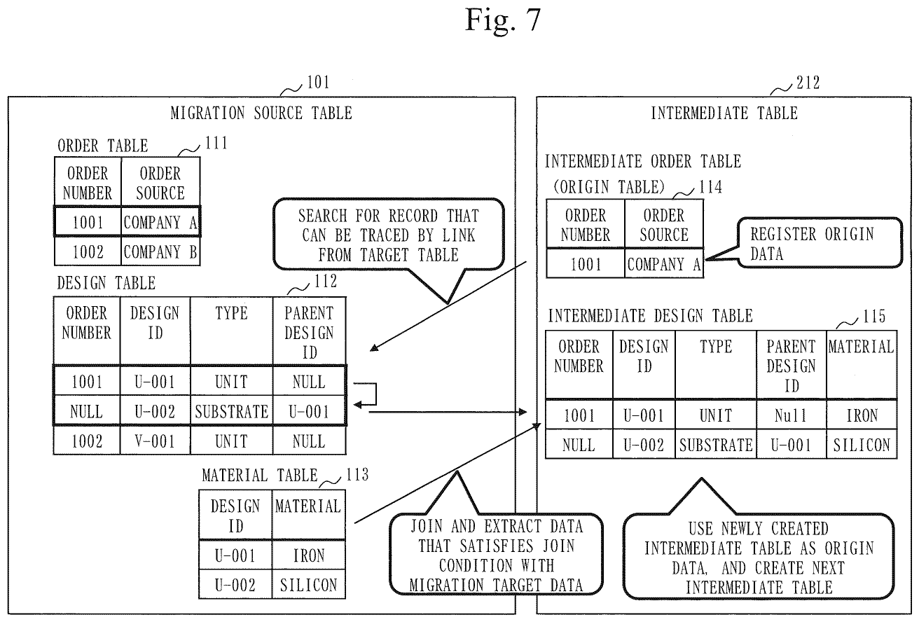

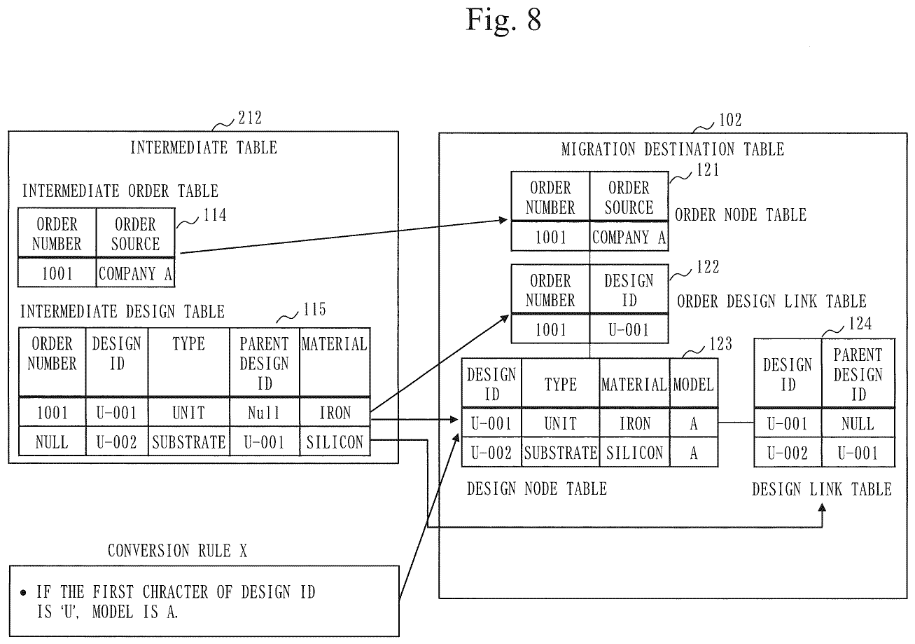

Referring to FIGS. 7 and 8, a specific example of the operation of the data migration device 10 according to Embodiment 1 will be described.

FIGS. 7 and 8 indicate processes to create intermediate data according to the example in FIG. 1. However, in the example indicated in FIG. 7, material information is added to the design node table 123 in the migration destination table 102. Therefore, a material table 113 in the migration source table 101 is newly added for reference.

Referring to FIG. 7, a specific example of the data extraction process (step S102 in FIG. 4) according to Embodiment 1 will be described.

In the example in FIG. 7, data associated with data of order number 1001 in the order table 111 is set as a migration target. Therefore, first, the origin data acceptance unit 21 registers the migration target data in the order table, which is origin data, in the origin table 211 (step S201). Here, the migration target data in the order table is registered in an intermediate order table 114, which has the role of the origin table 211. The data extraction unit 22 sets the design table 112 as a target table, and generates an intermediate design table 115 as a corresponding table (step S202).

The data extraction unit 22 executes an extraction query corresponding to the intermediate design table 115, and registers intermediate data in the intermediate design table 115. With this extraction query, the following data processing is performed by the DBMS of the migration source database 201.

A search is performed for a record in the design table 112 that can be traced by a link from the intermediate order table 114 (step S203). Further, a search is performed recursively for a record that can be traced by a link within the design table 112 (step S205). The data of each record that is found by the search becomes migration target data. In the migration destination table 102, material information is added to design information. Therefore, the material table 113 is joined to the design table 112 using the design ID as a key (step S207). Then, necessary data items are registered in the intermediate design table 115 from the joined table (step S208). The intermediate design table 115 has items of design ID, type, and material as node information of the design table 112 and the material table 113. The intermediate design table 115 has an order number as link information with the order table 111. The intermediate design table 115 has a parent design ID as link information in the design table 112. In this way, intermediate data is registered in the intermediate design table 115 by the extraction query.

Then, the data extraction unit 22 determines whether there is any other intermediate table to be created from the intermediate order table 114 (step S209). If there is none, the data extraction unit 22 determines whether the intermediate design table 115 that has been created is to be treated as the origin table 211 (step S211). If it is treated as the origin table 211, the data extraction unit 22 repeats the process using the intermediate design table 115 as the origin table 211. In this way, all intermediate tables are created.

Referring to FIG. 8, a specific example of the separation process (step S103 in FIG. 4) according to Embodiment 1 will be described.

The example in FIG. 8 indicates a process of converting the intermediate data created in FIG. 7 to a data model of the migration destination table 102. Note that FIG. 8 indicates the example in which a data conversion process of generating a model value from a design ID using a conversion rule X is also performed.

The separation unit 23 selects the intermediate order table 114 as the target intermediate table 212 (step S301). The intermediate order table 114 does not require data item conversion (step S302). Therefore, the separation unit 23 extracts node information (step S304). Then, the data registration unit 25 registers the node information in the order node table 121. The intermediate order table 114 has neither inter-table link information nor intra-table link information (step S305, step S307). Therefore, regarding the intermediate order table 114, the process ends with the extraction of node information.

Next, the separation unit 23 selects the intermediate design table 115 as the target intermediate table 212 (step S309, step S301). The data items of the intermediate design table 115 need to be converted based on the conversion rule X (step S302). Therefore, the conversion unit 24 converts the data items in accordance with the conversion rule X (step S303). As a result, a model item is added to each record in the intermediate design table 115.

The separation unit 23 extracts node information from the intermediate design table 115 and the newly added model items (step S304). Then, the data registration unit 25 registers the node information in the design node table 123. The intermediate design table 115 has link information with the intermediate order table 114 (step S305). Therefore, the separation unit 23 extracts inter-table link information from the intermediate design table 115 (step S306). Then, the data registration unit 25 registers the inter-table link information in the order design link table 122. Here, an order number is extracted as the inter-table link information and is registered in the order design link table 122 together with the design ID, which is a key item. Further, the intermediate design table 115 has intra-table link information (step S307). Therefore, the separation unit 23 extracts the intra-table link information from the intermediate design table 115 (step S308). Then, the data registration unit 25 registers the intra-table link information in the design link table 124. Here, a parent design ID is extracted as the intra-table link information and is registered in the design link table 124 together with the design ID, which is a key item.

In this way, the intermediate data is converted into a model of the migration destination table 102.

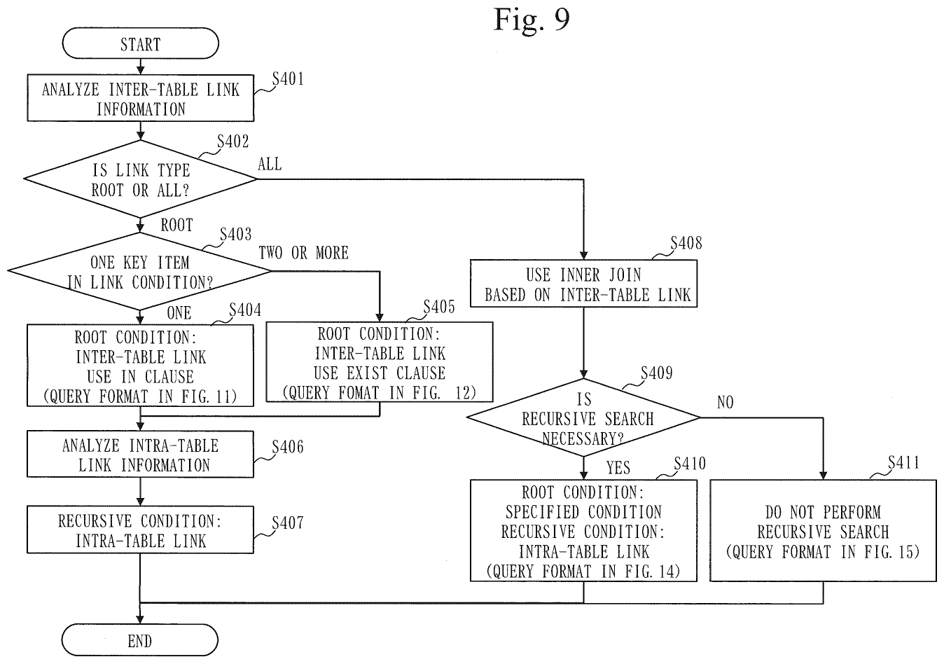

Referring to FIGS. 9 to 23, the query generation process according to Embodiment 1 will be described.

An extraction query is a query that collectively executes the processes corresponding to steps S202 to S208 in FIG. 5. The extraction query performs searches for migration target data based on the link information of steps S202 to S205. Then, the extraction query acquires necessary data items of steps S206 to S208 and registers them in the intermediate table.

In the following, a method for generating a query that searches for migration target data will be described first. Then, a method for generating an extraction query as a whole including acquirement of data items will be described.

One possible method for generating an extraction query is to prepare an SQL statement format as a template query, which is a template for queries, and set necessary setting information (strings) in the template query. Therefore, in Embodiment 1, an extraction query is generated by the query generation unit 26 by analyzing the query generation information 33 and setting, in a template query prepared in advance, setting information in an appropriate format.

The query generation information 33 is set in advance by the user of the data migration device 10. The query generation information 33 is set depending on the migration target data. When the query generation information 33 is being set, the data migration device 10 may assist the user by, for example, displaying the meta information 32. For example, it may be arranged that existing table names and data items are acquired in advance, and the user selects and thereby inputs table names and data items from a list.

Depending on how tables are managed in the migration source database 201, necessary join conditions between tables and so on may become special. In this case, the user (system developer) needs to change information that can be input as the query generation information 33, depending on that special process.

Referring to FIG. 9, a method for generating a query that searches for migration target data according to Embodiment 1 will be described.

### (Step S401: Inter-Table Link Analysis Process)

The query generation unit 26 analyzes the inter-table link 34 in the query generation information 33.

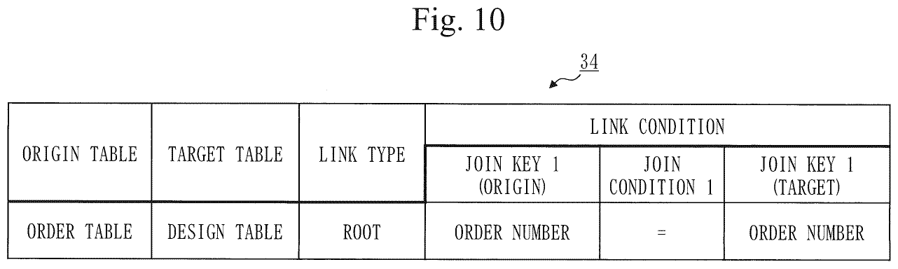

As indicated in FIG. 10, the inter-table link 34 has information on an origin table representing a link source, a target table representing a link destination, a link type to be described later, and a link condition for each link between tables used in a search. The link condition is composed of one set or a plurality of sets of a join key of an origin table, a join condition, and a join key of a target table. The join condition is a condition such as equal values.

The link type indicates whether the parent-child relationship of records between the origin table and the target table is one-to-one or one-to-many. In the case of one-to-one, the link type is set as root. In the case of one-to-many, the link type is set as all.

The link type of root represents that data in the target table that can be traced from the origin table by a link is the root in a link (parent-child relationship) in the target table. The link type of all represents that in the target table, every piece of migration target data is data that can be traced from the origin table by a link. For example, a case will be considered where a serial number of a device and serial numbers of components constituting the device are managed in different tables. In this case, if the device is treated as a top-level component and the device is managed as one record in a table that manages serial numbers of components, the link type is root. If the device is treated independently from its components and each of the components constituting the device has device information indicating the device, the link type is all.

### (Step S402: Link Type Determination Process)

The query generation unit 26 determines whether the link type between the origin table and the target table is root or all in the inter-table link 34.

If the link type is root, the query generation unit 26 advances the process to step S403. If the link type is all, the query generation unit 26 advances the process to step S408.

### (Step S403: Key Item Determination Process)

The query generation unit 26 determines whether there is one key item in the link condition in the inter-table link 34. The key item in the link condition is an item that indicates that the origin table and the target table are linked.

If there is one key item, the query generation unit 26 advances the process to step S404. If there are a plurality of key items, the query generation unit 26 advances the process to step S405.

### (Step S404: First Query Generation Process)

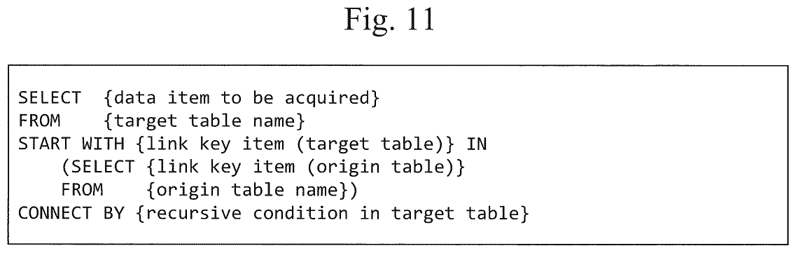

The query generation unit 26 generates an extraction query by expressing the link condition between the tables using an IN clause in an SQL statement, as in the template query indicated in FIG. 11. The IN clause is used to express the condition that the key item in the target table is included in the key item in the origin table.

In Embodiment 1, SQL statements when using an ORACLE (registered trademark) database are used as examples.

### (Step S405: Second Query Generation Process)

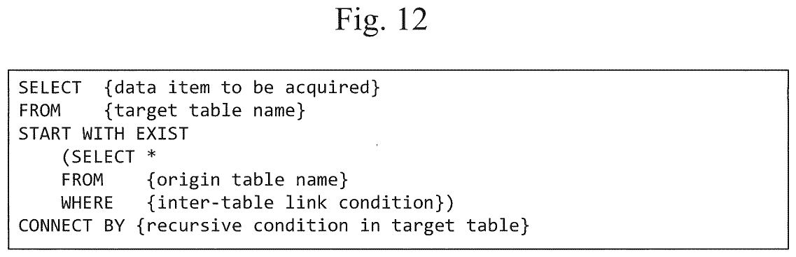

The query generation unit 26 generates an extraction query by expressing the link condition between the tables using an EXIST clause in an SQL statement, as in the template query indicated in FIG. 12. The EXIST clause is used to express the condition that the set of key items in the target table exists as the set of key items in the origin table.

### (Step S406: Intra-Table Link Analysis Process)

The query generation unit 26 analyses the intra-table link 35 in the query generation information 33 to determine whether a recursive search is necessary.

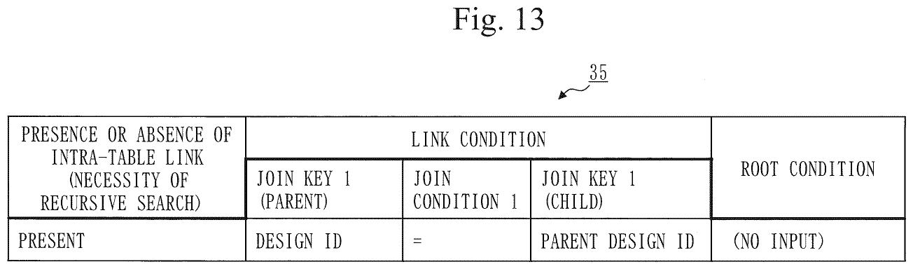

As indicated in FIG. 13, the intra-table link 35 has information on the presence or absence of an intra-table link (whether a recursive search is necessary), a link condition, and, if necessary, a root condition. The link condition is composed of one set or a plurality of sets of a join key of a parent record, a join condition, and a join key of a child record.

### (Step S407: Recursive Condition Decision Process)

If the presence of an intra-table link is indicated in the intra-table link 35, the query generation unit 26 sets a recursive search condition in the extraction query. Specifically, the query generation unit 26 sets the link condition in the intra-table link 35 in the CONNECT clause in FIG. 11 or 12.

If the absence of an intra-table link is indicated in the intra-table link 35, the query generation unit 26 deletes the recursive search condition from the extraction query. Specifically, the query generation unit 26 deletes the CONNECT clause in FIG. 11 or 12.

### (Step S408: Inner Join Generation Process)

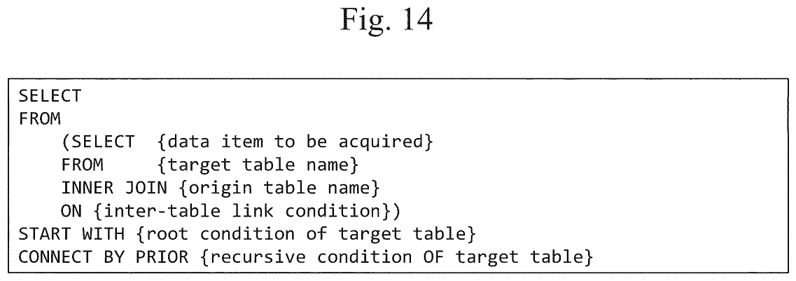

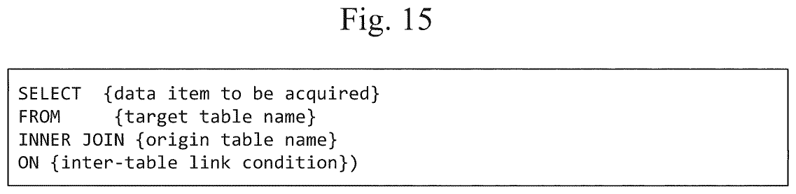

The query generation unit 26 expresses the inter-table link condition by an inner join of the origin table and the target table, as in the template queries indicated in FIGS. 14 and 15. In FIGS. 14 and 15, an inner join is expressed as INNER JOIN. This identifies the migration target data.

### (Step S409: Recursive Search Determination Process)

The query generation unit 26 analyzes the intra-table link 35 in the query generation information 33, and determines whether a recursive search is necessary, as in step S406.

If a recursive search is necessary, the query generation unit 26 advances the process to step S410. If a recursive search is not necessary, the query generation unit 26 advances the process to step S411.

One possible case where a recursive search is necessary is a case where data associated with a specified root condition is migration target data. For example, it is assumed that data related to prototype products and data related to shipped products are managed together as manufacture data. In this case, if only the data related shipped products is to be extracted as manufacture data associated with a certain order number, a shipped product needs to be specified as a root condition.

### (Step S410: Third Query Generation Process)

The query generation unit 26 sets the root condition specified in the intra-table link 35 as a root condition, and sets the join condition specified in the intra-table link 35 as a recursive condition. Then, the query generation unit 26 generates an extraction query by expressing the link condition between the tables using an inner join in an SQL statement, as in the template query indicated in FIG. 14.

### (Step S411: Fourth Query Generation Process)

The query generation unit 26 generates an extraction query by expressing the link condition between the tables using an inner join in an SQL statement without using a recursive condition, as in the template query indicated in FIG. 15.

In steps S404, S405, S408, S410, and S411, the query generation unit 26 sets information enclosed in curly brackets by converting it into an appropriate string. The information enclosed in curly brackets is extracted from the inter-table link 34 indicated in FIG. 10 and the intra-table link 35 indicated in FIG. 13.

For example, in step S404, the template query indicated in FIG. 11 is used. Then, the value of the target table in FIG. 10 is set in {target table name}. The value of the join key 1 (target) in FIG. 10 is set in {link key item (target table)}. The value of the join key 1 (origin) in FIG. 10 is set in {link key item (origin table)}. The value of the origin table in FIG. 10 is set in {origin table name}. The value of the link condition in FIG. 13 is set in {recursive condition in target table}.

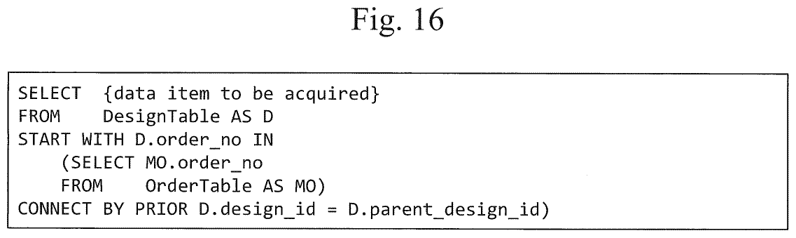

The design table is expressed as “DesignTable”. The order number is expressed as “order_no”. The order table is expressed as “OrderTable”. The design ID is expressed as “design_id”. The type is expressed as “type”. The parent design ID is expressed as “parent_design_id”. Then, the extraction query is generated as indicated in FIG. 16.

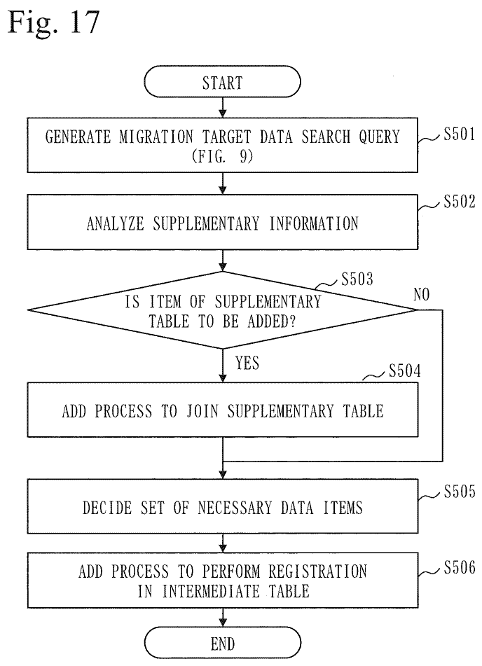

Referring to FIG. 17, a process of generating a query including acquirement and registration of data items according to Embodiment 1 will be described.

### (Step S501: Search Query Generation Process)

The query generation unit 26 generates the part of an extraction query that performs a search by the processes described with reference to FIG. 9.

### (Step S502: Supplementary Information Analysis Process)

The query generation unit 26 analyzes the supplementary information 37 in the query generation information 33.

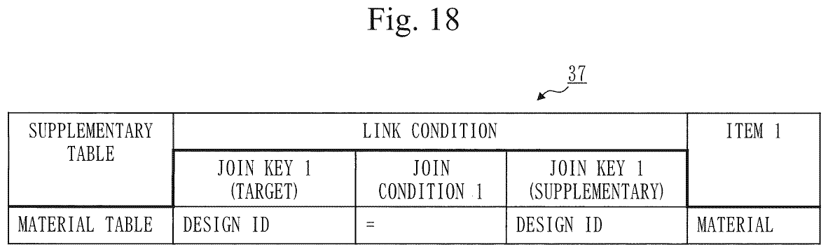

As indicated in FIG. 18, the supplementary information 37 has a link condition and a join item for each supplementary table. The link condition is composed of one set or a plurality of sets of a join key of a target table, a join condition, and a join key of a supplementary table. The join item is an item to be added to the target table. There may be one or more join items.

### (Step S503: Addition Determination Process)

The query generation unit 26 determines whether an item of the supplementary table is to be added.

Specifically, if data is set in the supplementary information 37, the query generation unit 26 determines that an item of the supplementary table is to be added. If data is not set in the supplementary information 37, the query generation unit 26 determines that an item of the supplementary table is not to be added.

If an item of the supplementary table is to be added, the query generation unit 26 advances the process to step S504. If an item of the supplementary table is not to be added, the query generation unit 26 advances the process to step S505.

### (Step S504: Item Addition Process)

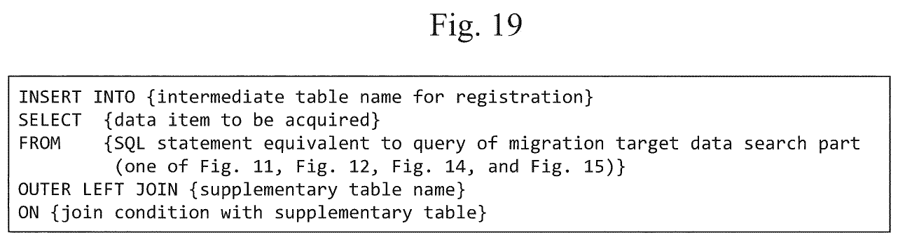

The query generation unit 26 adds a process to add the join item of the supplementary table to the current extraction query. Specifically, the query generation unit 26 specifies the supplementary table as an outer join, and sets the link condition in the supplementary information 37 as an outer join condition, as in the template query indicated in FIG. 19. If there are a plurality of supplementary tables, the same number of outer joins as the number of supplementary tables are used.

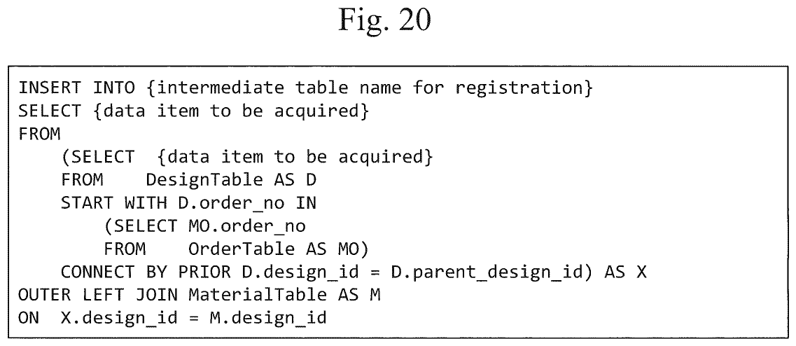

For example, it is assumed that the supplementary information 37 indicated in FIG. 18 is set. The material table is expressed as “MaterialTable”. The material is expressed as “material”. In this case, a process to join the supplementary table to the extraction query indicated in FIG. 16 is added. Then, the extraction query indicated in FIG. 20 is generated.

### (Step S505: Acquirement Item Setting Process)

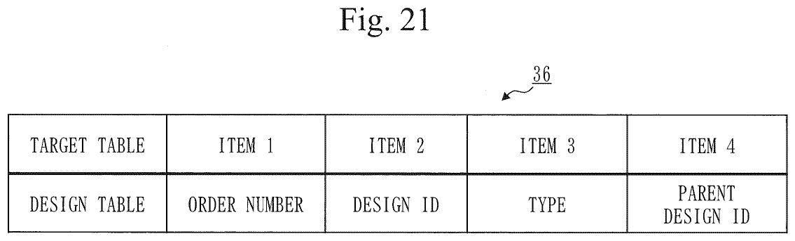

The query generation unit 26 analyzes the intra-table node 36 of the query generation information 33. As indicated in FIG. 21, the intra-table node 36 has an extraction target item in the target table. There may be one or more extraction target items. The query generation unit 26 sets each item of the intra-table node 36 and the join item of the supplementary information 37 in the current extraction query as data items to be acquired.

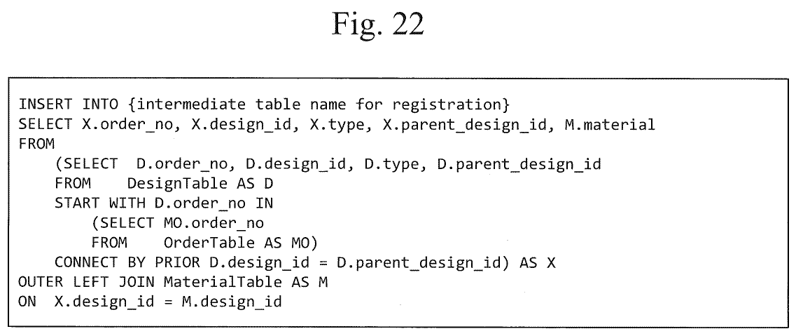

It is assumed that the intra-table node 36 is set as indicated in FIG. 21. In this case, the value of each item indicated in FIG. 21 and the value of the join item indicated in FIG. 18 are set in {data items to be acquired} in the extraction query in FIG. 20. Then, the extraction query indicated in FIG. 22 is generated.

### (Step S506: Registration Process Setting Process)

The query generation unit 26 adds a process to register the intermediate data in the intermediate table to the current extraction query. Specifically, the intermediate table of the registration destination is set in {registration intermediate table name} in the template query indicated in FIG. 19.

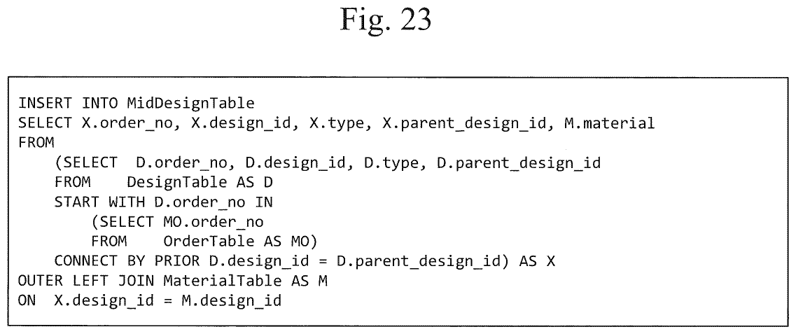

For example, it is assumed that the intermediate table of the registration destination is the intermediate design table. The intermediate design table is expressed as “MidDesignTable”. In this case, the intermediate table of the registration destination is set in the extraction query indicated in FIG. 22, and the extraction query indicated in FIG. 23 is generated.

By generating an extraction query, the data items and types of intermediate data are also decided concurrently. Therefore, the query generation unit 26 generates a definition query that defines the intermediate table 212 based on the data items and types of intermediate data.

### Effects of Embodiment 1

As described above, the data migration device 10 according to Embodiment 1 extracts a record that can be traced based on link information using origin data as a starting point, and writes the record in the intermediate table 212. That is, node information and link information associated with the origin data are collectively written to the intermediate table. Then, the data migration device 10 separates data in the intermediate table 212 into the node information and the link information, and writes them to the migration destination database 202.

By separating the processes using the intermediate table 212, the processes are simplified. This reduces the burden of developing a program or the like necessary for migration, and makes it possible to easily migrate data.

In desired data migration, data associated with a specific condition is extracted from the migration source table 101 in which node information and link information are managed together. Then, after a data model of the data is converted, the data is copied and migrated to the migration destination table 102 in which node information and link information are managed separately.

The data migration device 10 according to Embodiment 1 uses the intermediate table 212 for extracting node information and link information associated with a specific condition together. This simplifies the processes. The data to be registered in the intermediate table 212 can be created using an SQL statement automatically generated based on the query generation information 33 input by the user. This can reduce development effort.

Conventional coding or commercially available tools require complex implementation to realize desired data migration. However, by using the data migration device 10 according to Embodiment 1, part of the processes can be realized by setting simple parameters (the query generation information 33). This can reduce development effort.

The part of the processes is realized by setting parameters. Therefore, even if the specifications of the data migration process is changed, the scope of modification can be kept small. This can improve the maintainability of the data migration system.

The data migration device 10 according to Embodiment 1 extracts and migrates data associated with a specific condition. Therefore, by extracting data associated with a new order or the like, a data update of the migration source table 101 can be reflected in the migration destination table 102.

When data migration involving conversion of a data model is performed, it is difficult to identify data update portions in the migration destination table 102 by simply identifying data update portions in the migration source table 101. Even when conversion of a data model is required, the data migration device 10 according to Embodiment 1 allows data update portions before the conversion to be reflected also in a result of the conversion.

The data migration device 10 according to Embodiment 1 can extract data associated with a specific customer or the like. Such processing is necessary to realize data linkage between stakeholders. Therefore, the data migration device 10 for easily realizing desired data migration is important for realizing advanced DX in the manufacturing industry.

### Other Configurations

### Variation 1

In Embodiment 1, the functional components are realized by software. However, as Variation 1, the functional components may be realized by hardware. With regard to this Variation 1, differences from Embodiment 1 will be described.

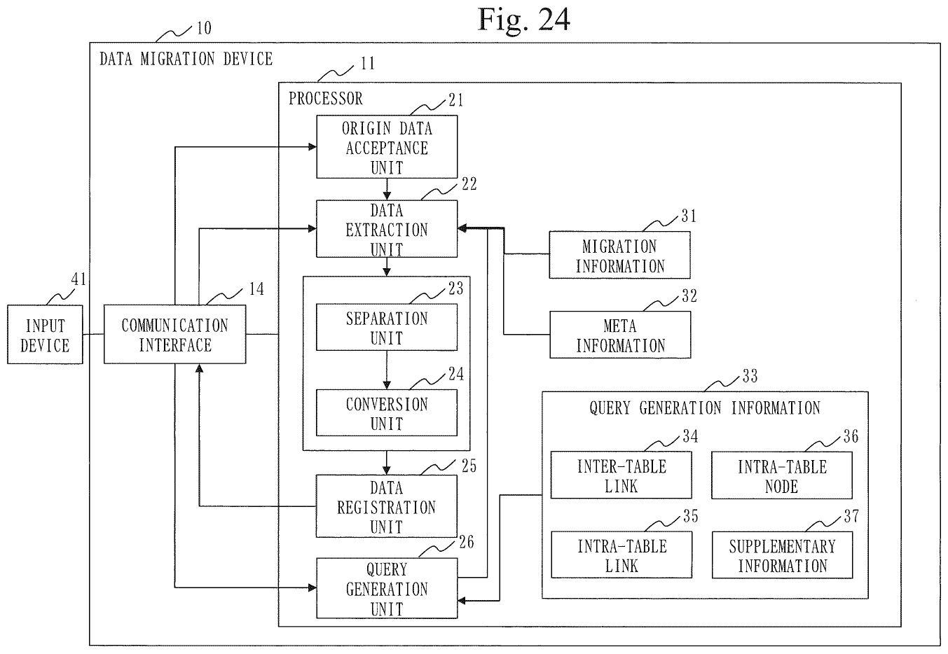

Referring to FIG. 24, a configuration of the data migration device 10 according to Variation 1 will be described.

When the functional components are realized by hardware, the data migration device 10 includes an electronic circuit 15 in place of the processor 11, the memory 12, and the storage 13. The electronic circuit 15 is a dedicated circuit that realizes the functions of the functional components, the memory 12, and the storage 13.

The electronic circuit 15 is assumed to be a single circuit, a composite circuit, a programmed processor, a parallel-programmed processor, a logic IC, a GA, an ASIC, or an FPGA. GA is an abbreviation for gate array. ASIC is an abbreviation for application specific integrated circuit. FPGA is an abbreviation for field-programmable gate array.

The functional components may be realized by one electronic circuit 15, or the functional components may be distributed to and realized by a plurality of electronic circuits 15.

### Variation 2

As Variation 2, some of the functional components may be realized by hardware, and the rest of the functional components may be realized by software.

Each of the processor 11, the memory 12, the storage 13, and the electronic circuit 15 is referred to as processing circuitry. That is, the functions of the functional components are realized by the processing circuitry.

### Embodiment 2

Embodiment 2 differs from Embodiment 1 in that data items extracted from the migration source table 101 are converted and then written to the intermediate table 212. In Embodiment 2, this difference will be described, and description of the same aspects will be omitted.

### Description of Configuration

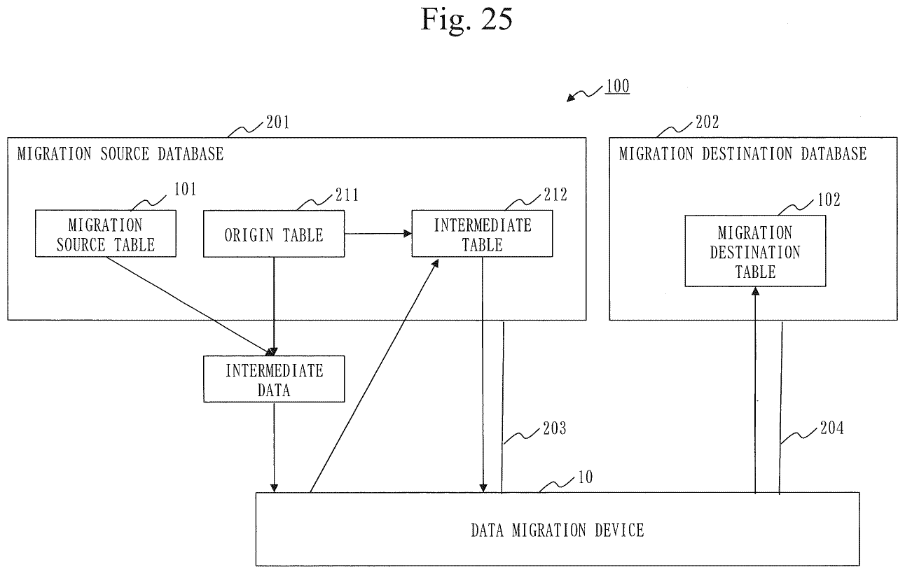

Referring to FIG. 25, a configuration of the data migration system 1 according to Embodiment 2 will be described.

The data migration system 1 according to Embodiment 2 is configured such that intermediate data extracted from the migration source table 101 is passed to the data migration device 10 once, is converted, and then is written to the intermediate table 212.

### Description of Operation

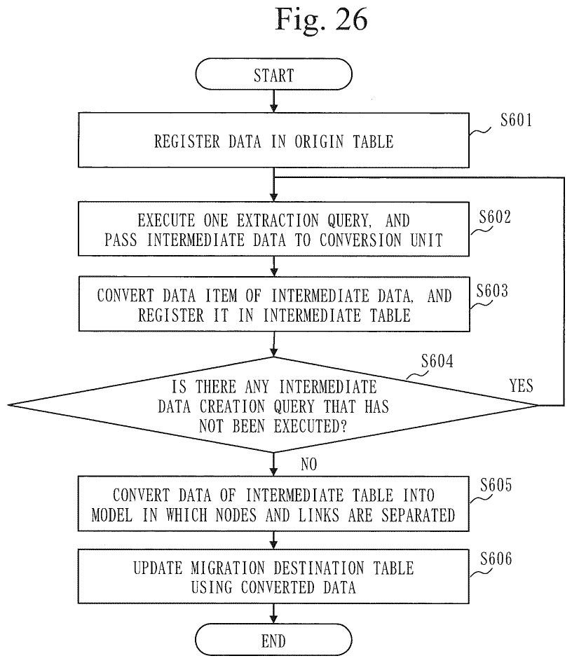

Referring to FIGS. 26 to 28, the operation of the data migration device 10 according to Embodiment 2 will be described.

A procedure for the operation of the data migration device 10 according to Embodiment 2 is equivalent to the data migration method according to Embodiment 2. A program that realizes the operation of the data migration device 10 according to Embodiment 2 is equivalent to the data migration program according to Embodiment 2.

Referring to FIG. 26, an outline of the data migration process according to Embodiment 2 will be described.

Step S601 is the same as step S101 in FIG. 4. The processes of steps S605 to S606 are the same as the processes of steps S103 to S104 in FIG. 4.

### (Step S602: Data Extraction Process)

The data extraction unit 22 extracts migration target data as intermediate data by executing one extraction query of one or more extraction queries. The data extraction unit 22 passes the extracted intermediate data to the conversion unit 24.

By branching in step S604, all the extraction queries are executed in the end.

### (Step S603: Data Extraction Process)

The conversion unit 24 converts the intermediate data passed in step S602 in accordance with the conversion rule. The conversion unit 24 returns the converted intermediate data to the data extraction unit 22. Then, the data extraction unit 22 writes the converted intermediate data to the intermediate table 212.

### (Step S604: Query Determination Process)

The data extraction unit 22 determines whether there is an extraction query that has not been processed.

If there is an extraction query that has not been processed, the data extraction unit 22 returns the process to step S602. If there is no extraction query that has not been processed, the data extraction unit 22 advances the process to step S605.

Use examples assumed in Embodiment 2 will be described.

There may be a case where the formats of join keys are different between linked tables in the migration source table 101. There may also be a case where the format of a primary key needs to be changed between the migration source table 101 and the migration destination table 102.

A case will be described where the formats of join keys are different between linked tables in the migration source table 101. That the formats of join keys are different between linked tables means that information for tracing a link between these tables is available as data items, but the link cannot be traced using a simple condition such as a match between the values of the data items. In this case, in Embodiment 1, the query generation unit 26 cannot generate an extraction query. Therefore, in Embodiment 2, the conversion unit 24 converts a data item related to a link condition between the tables, adds a join key that is unified between the tables to intermediate data, and then registers the intermediate data in an intermediate table. This allows the query generation unit 26 to generate an extraction query.

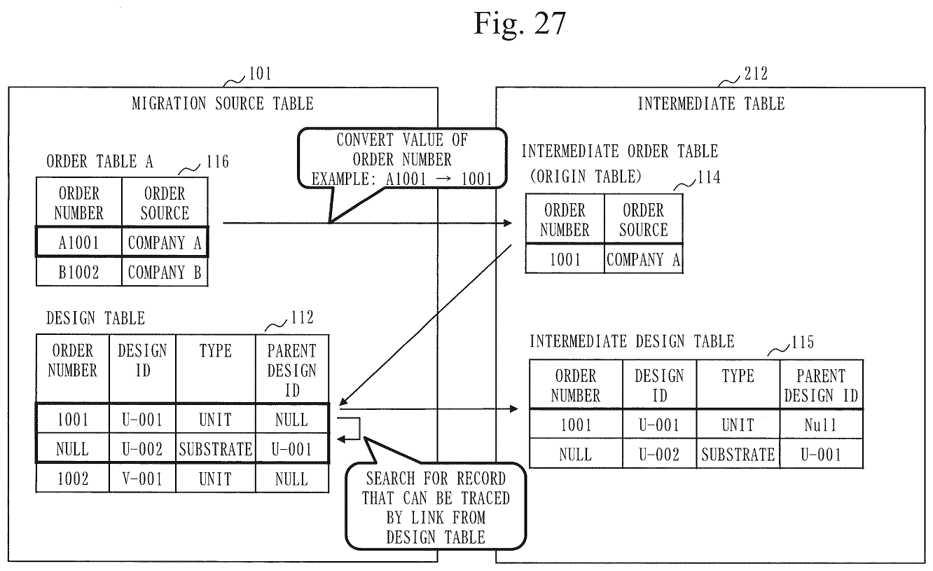

Referring to FIG. 27, a specific example will be described.

In an order table A 116, the order number is in a format that includes information on the order source, which is different from the order table 111 in FIG. 7. Therefore, if data is simply registered in the intermediate order table 114, a link to the design table 112 cannot be traced. Therefore, the conversion unit 24 converts the value of a data item acquired from the migration source table 101 into a unified format, and then registers it in the intermediate table 212 (step S603). In FIG. 27, the order number is converted from A1001 to 1001. In the example, the conversion unit 24 performs data conversion for the origin table 211. However, the conversion unit 24 similarly performs data conversion also for the intermediate table 212 created based on the origin table 211.

A case will be described where the format of the primary key needs to be changed between the migration source table 101 and the migration destination table 102. In Embodiment 1, the conversion unit 24 requires a process to change the primary key in each of a process to output node information and a process to output link information from the intermediate table 212. Therefore, when the intermediate table 212 is created, the conversion unit 24 adds in advance an item that is a result of changing the primary key to the intermediate table 212. Then, in the process to output each of node information and link information, it is sufficient to refer to the result of changing. This can reduce necessary processes.

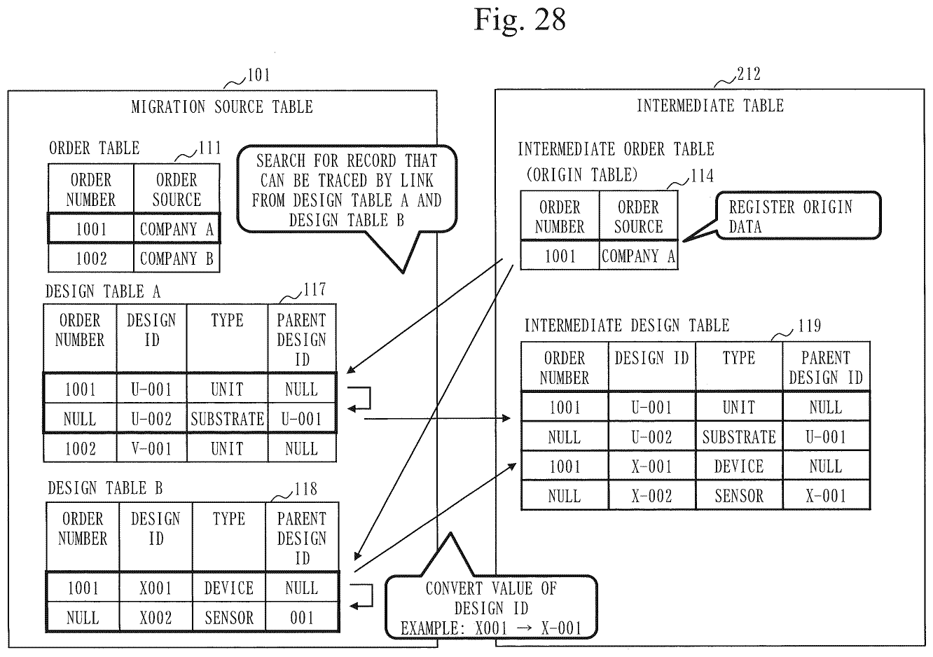

Referring to FIG. 28, a specific example will be described. In the migration source table 101 in FIG. 28, design information is managed in different tables, which are a design table A 117 and a design table B 118. Note that these tables have different design ID formats. The design ID is in a format that includes a hyphen such as U-001 in the design table A, whereas the design ID is in a format that does not include a hyphen such as X001 in the design table B.

It is assumed here that data needs to be managed in a unified format that includes a hyphen in the migration destination table 102. In this case, data is registered in an intermediate design table 119 in the format of the migration source table 101 (format that does not include a hyphen). Then, the format needs to be converted in each of the process to output node information and the process to output link information by the separation unit 23.

In Embodiment 2, the conversion unit 24 converts a data item in the migration source table 101, and then registers the data in the intermediate table 212. In the example in FIG. 28, the conversion unit 24 converts the value of the design ID of each record in the design table B and then registers it in the intermediate table 212. This allows the conversion process to be completed in one step. This example indicates a case where design information is distributed across two tables. However, in a case where only one table exists (for example, only the design table B exists), the conversion unit 24 performs substantially the same processing.

### Effects of Embodiment 2

The data migration device 10 according to Embodiment 2 is effective when the data formats differ between tables in the migration source table 101. The data migration device 10 according to Embodiment 2 is also effective when data needs to be managed in the migration destination table 102 in a format different from that in the migration source table 101.

In a corporate business system, long-term information exists for each business division. Therefore, data formats may not necessarily be unified. By using the data migration device 10 according to Embodiment 2, desired data migration can be realized even between such different data formats.

In the migration destination table 102, it is necessary to make it possible to correctly trace a relationship (link) for each piece of data. Therefore, it is necessary to have a unified data format between stakeholders that share data. However, an existing migration source table 101 is normally in a data format that is intended only for the business system of the company concerned. Therefore, in desired data migration, it may be necessary to change the data format before migration. Embodiment 2 is effective also in such a case.

“Unit” in the above description may be interpreted as “circuit”, “step”, “procedure”, “process”, or “processing circuitry”.

The embodiments and variations of the present disclosure have been described above. Two or more of these embodiments and variations may be implemented in combination. Alternatively, one of them or two or more of them may be partially implemented. The present disclosure is not limited to the above embodiments and variations, and various modifications can be made as necessary.

### REFERENCE SIGNS LIST

1: data migration system, 10: data migration device, 11: processor, 12: memory, 13: storage, 14: communication interface, 21: origin data acceptance unit, 22: data extraction unit, 23: separation unit, 24: conversion unit, 25: data registration unit, 26: query generation unit, 31: migration information, 32: meta information, 33: query generation information, 34: inter-table link, 35: intra-table link, 36: intra-table node, 37: supplementary information, 101: migration source table, 102: migration destination table, 111: order table, 112: design table, 113: material table, 114: intermediate order table, 115: intermediate design table, 116: order table A, 117: design table A, 118: design table B, 119: intermediate design table, 121: order node table, 122: order design link table, 123: design node table, 124: design link table, 201: migration source database, 202: migration destination database, 203: transmission channel, 204: transmission channel, 211: origin table, 212: intermediate table.

1. A data migration device comprising
processing circuitry to:
extract a record from a migration source database in which node information managed in a target record and link information representing a link to another record are managed together in a same table, the record being a record that can be traced based on the link information using origin data as a starting point, and write the record to an intermediate table;
read, from the intermediate table, the extracted record, and separate data of the record into the node information and the link information; and
register the node information and the link information that have been separated in a migration destination database in which the node information and the link information are managed separately.

2. The data migration device according to claim 1,
wherein the link information represents a link to a record in another table,
wherein the processing circuitry performs an extraction process of using each of one or more other tables containing a record linked from the origin data by the link information as a target table, generating a corresponding table corresponding to the target table as the intermediate table, extracting a record linked from the origin data by the link information from the target table, and writing the record to the corresponding table, and
wherein the processing circuitry performs the extraction process recursively using data of the record registered in the intermediate table as new origin data.

3. The data migration device according to claim 2,
wherein the link information represents a link to another record in the same table, and
wherein the processing circuitry extracts another record in the target table linked by the link information from data of the record extracted from the target table, and writes the another record to the corresponding table.

4. The data migration device according to claim 2,
wherein when a supplementary table to be joined to the target table is specified, the processing circuitry generates the corresponding table including an item of the target table and an item of the supplementary table, extracts a record in the target table that is linked from the origin data by the link information so as to write the record to the corresponding table, and also extracts a record in the supplementary table that satisfies a join condition with data of the record that has been extracted so as to write the record in the supplementary table to the corresponding table.

5. The data migration device according to claim 1,
wherein the processing circuitry converts a specified data for which a conversion rule is specified in accordance with the conversion rule.

6. The data migration device according to claim 5,
wherein the processing circuitry converts data of the record that has been extracted, and then writes the data that has been converted to the intermediate table.

7. The data migration device according to claim 1,
wherein the processing circuitry generates an extraction query that extracts, from the migration source database, a record that can be traced based on the link information using the origin data as a starting point, and
wherein the processing circuitry extracts the record by executing the generated extraction query.

8. The data migration device according to claim 7,
wherein the processing circuitry refers to query generation information including a selection condition and setting information, and generates the extraction query by setting the setting information in a template query corresponding to the selection condition among a plurality of template queries.

9. A data migration method comprising:
extracting a record from a migration source database in which node information managed in a target record and link information representing a link to another record are managed together in a same table, the record being a record that can be traced based on the link information using origin data as a starting point, and writing the record to an intermediate table;
reading, from the intermediate table, the record that has been extracted, and separating data of the record into the node information and the link information; and
registering the node information and the link information that have been separated in a migration destination database in which the node information and the link information are managed separately.

10. A non-transitory computer readable medium storing a data migration program that causes a computer to function as a data migration device to perform:
a data extraction process of extracting a record from a migration source database in which node information managed in a target record and link information representing a link to another record are managed together in a same table, the record being a record that can be traced based on the link information using origin data as a starting point, and writing the record to an intermediate table;
a separation process of reading, from the intermediate table, the record extracted by the data extraction process, and separating data of the record into the node information and the link information; and
a data registration process of registering the node information and the link information separated by the separation process in a migration destination database in which the node information and the link information are managed separately.
